(19) United States
(12) Patent Application Publication
(10) Pub. No.: US 2002/0149568 A1
(43) Pub. Date: Oct. 17, 2002

(54) Keyboard having changeable key display

(76) Inventor: Richard Kim, L.A., CA (US)

Correspondence Address: RICHARD KIM, c/o Don Row, Suite 1000, 3700 Wilshire Blvd., Los Angeles, CA, 90010, US

(21) Appl. No.: 09/834,865

(22) Filed: Apr. 16, 2001

(51) Int. Cl. G09G 5/00

(52) U.S. Cl. 345/170

(57) ABSTRACT

A keyboard having keys, with each key having a special keybutton with a changeable label in the form of a liquid crystal display (LCD) screen is provided. The display on the screen is determined by the language selected by the user. A preprogrammed read only memory (PROM) for stores label data in a predetermined number of different languages. A switching means controls the selection of the language database of the PROM accessed and read by the microprocessor. The function of each key is independent of the character displayed thereon. That is, the function for each key remains the same even as the display for each key changes. A light is provided within each keybutton to allow use in low ambient light or in dark rooms. The intensity of the light is adjustable by use of a switch which could be a sliding knob or a rotatable dial.

### FIELD OF THE INVENTION

The present invention relates to display keyboards. More particularly, the present invention relates to a novel keyboard having display on keys that can change from one language character to another depending on the language program selected.

### BACKGROUND OF THE INVENTION

Keyboards, sometimes also referred to as keypads, have improved in many ways over the years. Much of the improvement comes in the layout of the keys to improve typing convenience and speed. Other improvement has been in the reduction of noise produced by the keys when a person types. Other improvement has been in the area of creating additional special function keys.

Typically the keys of a keyboard have one character printed on it corresponding to a particular function. If the character of the key is changed, the function of the key remains the same. The function of the key is independent of the changing of the character or image printed thereon.

However, more advanced keyboards, especially for computers, have been developed which have displays on the keys. One such keyboard is taught by Acevedo in U.S. Pat. No. 5,818,361. The keyboard in Acevedo has keys having a liquid crystal display (LCD) situated thereon for depicting characters and indicia. To control the operation of the keyboard, a conventional computer is connected to the keyboard and adapted to depict via the display keys characters and indicia relevant to the function of the key during a current software application. A disadvantage with this keyboard is that it is dependent on a computer having a software for displaying the characters on the keyboard.

A common disadvantage of the conventional keyboard is the inconvenience in typing in different language characters. One can type in different languages with a single keyboard by sticking a small character of a second language on empty spaces found on the corresponding keys having English character. However space on each key would become crowded and confusing if more than one additional language sticker is placed thereon.

Another disadvantage of the conventional keyboard is the absence of waterproof features built within the keyboard. There are protection devices for placement over the keyboard in the form of molded covers which fit over the face of the keys. However, these covers are separate parts which can be lost or easily worn out.

Thus, it would be desirable to have a keyboard having keys which can be switched to simultaneously display the characters of a language selected by the user. As such, a single keyboard would be capable of being utilized to type in a selected amount of languages. Further, it would be desirable to have a keyboard having built in waterproof capabilities.

A primary objective of the present invention is to provide a keyboard having a display on each key that can be changed to simultaneously display characters of different languages as selected by the user. Another objective of the present invention is to provide a display keyboard which is inexpensive to manufacture. Yet another objective of the present invention is to provide a keyboard having built in waterproof characteristics.

### SUMMARY

The present invention is a keyboard having keys, and each key has a special keybutton with a changeable label in the form of a liquid crystal display (LCD) screen. Each screen is capable of displaying a label of the key in a plurality of different languages.

The keyboard includes a preprogrammed read only memory (PROM) for storing label data in a number of different languages as determined by a programmer. A microprocessor connects to the PROM and reads screen label data and sends operating signals to a control unit. The control unit connects to an LCD driver circuit which in turn connects to each key.

A switching means controls the selection of the language database of the PROM accessed and read by the microprocessor. The switching means can be a predetermined number of select keys corresponding to the number of given language preprogrammed in the PROM. Pressing one of the desired select keys would cause the keys to simultaneously show the characters of the corresponding language from the PROM. In the alternative, the switching means can be a manual knob placed on the keyboard which can be moved into different positions depending on the language the user wants displayed of the keybuttons. Each predetermined position would correspond to a different language programmed in the PROM.

The function of each key is independent of the character displayed thereon. That is, the function for each key remains the same even as the display for each key changes.

The keypad of the present invention further comprises of a light to allow use in low ambient light or in dark rooms. The intensity of the light is adjustable by use of a switch which could be a sliding knob or a rotatable dial.

For waterproof capabilities, the keyboard further comprises a sheet of flexible material covering the inner components of the keyboard.

### DETAILED DESCRIPTION

The keyboard 10 of the present invention is shown in FIG. 1. The keyboard 10 according to the invention shown has keys 12 and each key 12 has a special keybutton 15 with a changeable label in the form of a liquid crystal display (LCD) screen 17 as best shown in FIG. 2. Each screen 17 is capable of displaying a label of the key 12 in a plurality of different languages.

Referring to FIG. 3, a block diagram of the circuit for operating the screen displays is shown. Each key 12 is connected by means of line to an LCD driver circuit 19. The driver circuit receives its operating signals from a control unit such as a microprocessor 20 via a bus. The microprocessor 20 is connected to and capable of reading screen label display data from a preprogrammed read only memory (PROM) 25. The PROM 25 stores label data in a plurality of different languages for each of the keys 12. The microprocessor 20 controls the PROM 25 and LCD driver 19 to read out display information in a given language from the PROM 25 and supply the read out display information to the LCD driver 19 for displaying labels of a given language on the displays of each of the keybuttons.

A switching means controls the predetermined language database of the PROM 25 accessed and read by the microprocessor 20. The switching means as shown in FIG. 1 can be a predetermined number of select keys 30 corresponding to the number of given language preprogrammed in the PROM 25. Each select key 30 would be pre-printed with an identifying marking corresponding to a particular language. For purposes of illustration, the select key 30 for Korean language could have the word “KOREAN” pre-printed on the corresponding select key. A user wanting the displays of each of the keybuttons to display Korean language characters would simply press this selector key labeled KOREAN, and the microprocessor would read the Korean language label data from the PROM and supply the read out display information to the LCD driver for displaying labels of Korean characters. Should the user want to display English characters, the user would simply push the select key pre-labeled for English, and the microprocessor would switch to read the English language label data from the PROM and supply the read out display information to the LCD driver for displaying labels of English characters.

In an alternative embodiment shown in Figure 1a, the switching means can be a manual knob 35 placed on the keyboard 10 which can be moved into different positions depending on the language the user wants displayed on the keybuttons 15. Each predetermined position would correspond to a different language programmed in the PROM 25. As the knob 35 is moved from one predetermined position to another, the microprocessor 20 switches to read the language label data from the PROM 25 for a different preprogrammed language. For instance, if the user wants Korean language characters on the keybuttons, the user would move the knob to the predetermined position corresponding to Korean, and the microprocessor would read the language label data from the PROM for Korean characters and supply the read out display information to the LCD driver for displaying Korean characters. To change the display to English characters, the user would move the knob to the predetermined position corresponding to English, and the microprocessor would read the language label data from the PROM for English characters and supply the read out display information to the LCD driver for displaying English characters.

The function of each key 12 is independent of the character displayed thereon. That is, the function for each key 12 remains the same even as the display for each key 12 changes.

The keyboard of the present invention further comprises of a light (not shown) to allow use in low ambient light or in dark rooms. The intensity of the light is adjustable by use of a switch which could be a sliding knob 40 (shown in FIG. 1) or a rotatable dial 42 (shown in FIG. 1A).

Further, the present invention comprises of a sheet member 53 of a flexible material for covering the inner components of the keyboard. Specifically, the inner components of the keyboard 10 include a pair of sheet-like membranes 55 each having electrically conductive contacts (not shown) arranged thereon. The pair of membranes 55 are separated by a plastic sheet (not shown) having a plurality of holes there-through. Further, the inner components of the keyboard 10 include a circuit board (not shown). The inner components also include a key sheet (not shown) made of a flexible material having a plurality of nipple-like protrusions extending therefrom, with each protrusion corresponding to the position of a key 12. The protrusion beneath each key 12 urges each key 12 in an original raised position. When a key is depressed, the protrusion is depressed, and when the key is released, the protrusion reforms into its original protruding shape thus raising the key 12 to the original raised position.

In an alternative embodiment, the inner components does not include a key sheet. Instead, the top surface 58 of the sheet member has a nipple-like protrusion extending therefrom, with each protrusion corresponding to the position of a key 12. The protrusion beneath each key 12 urges each key 12 in an original raised position. When a key is depressed, the protrusion is depressed, and when the key is released, the protrusion reforms into its original protruding shape thus raising the key 12 to the original raised position.

Although a preferred embodiment of the invention has been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claims which follow.

### BRIEF DESCRIPTION OF THE DRAWINGS

FIG. 1 is a top view of the present invention;

Figure 1a is a top view of the top half section of an alternative embodiment of the present invention;

FIG. 2 is a view of a keybutton of the present invention displaying the letter “K” in the English alphabet;

FIG. 2a is a view of the keybutton shown in FIG. 2 displaying the letter “K” in the Korean alphabet;

FIG. 3 is a block diagram of the interconnection of the components of the present invention;

FIG. 4 is a exploded perspective view of the present invention.

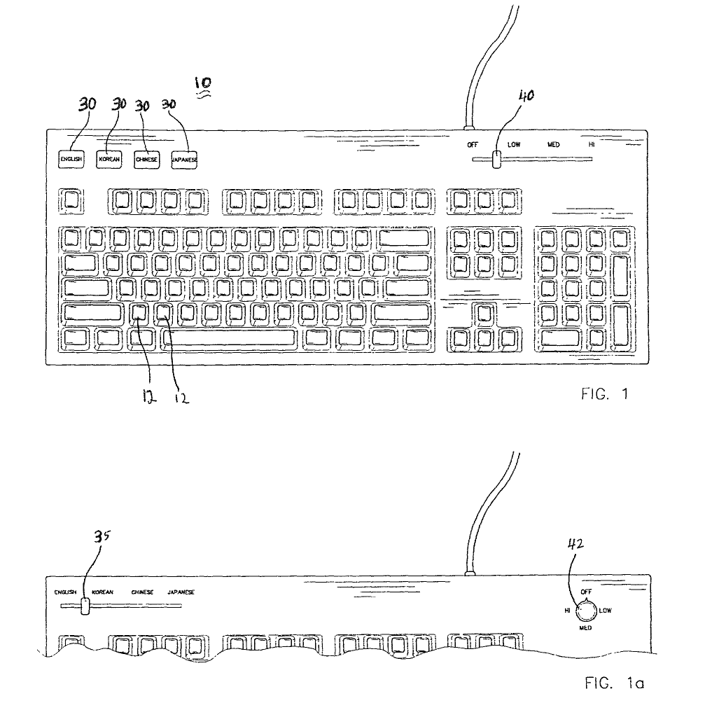

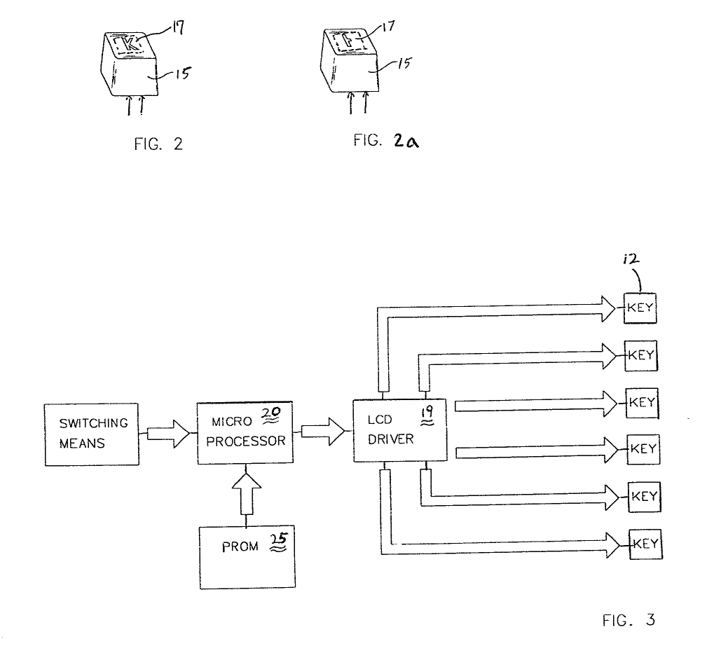

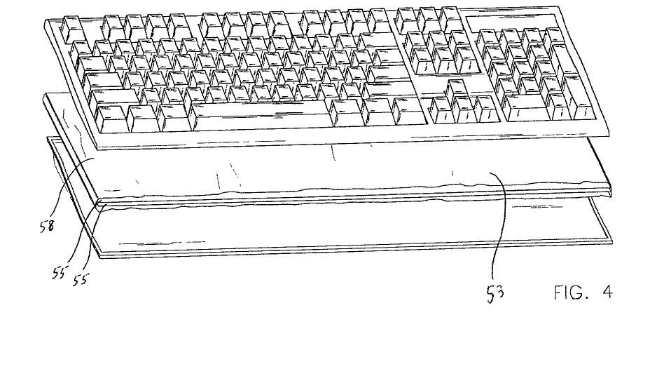

1. An improved keyboard for use with a computer, said keyboard comprising:
a housing board;
a plurality of keys disposed in a predetermined manner on said housing board;
each key having a changeable label thereon;
a programmable memory disposed within said board, said memory storing display information in a predetermined number of different languages;
a driver means connecting to said keys and said memory;
said driver means simultaneously supplying display information to said keys to cause the keys to display different displays in the same language; and,
a switching means for selecting from said memory a display information for a specific language.

2. A keyboard as described in claim 1 wherein each of said changeable labels includes a liquid crystal display (LCD) screen; and wherein said driver means is a LCD driver means.

3. An improved keyboard as described in claim 1 wherein said switching means comprises a manual sliding knob placed on the keyboard which can be moved into different positions depending on the language the user desires; each of said predetermined positions corresponding to a different language programmed in the memory; wherein as said knob is moved from one predetermined position to another, the language display selected from said memory switches accordingly.

4. An improved keyboard as described in claim 1 wherein said switching means comprises a predetermined number of selection keys disposed on said keyboard; each of said selections keys corresponding to a predetermined language display; wherein selecting a particular selection key selects a corresponding language display program in the memory.

5. An improved keyboard as described in claim 1 further comprising a light within each of said keys.

6. An improved keyboard as described in claim 5 further comprising a slideable control knob for controlling the intensity of said light.

7. An improved keyboard as described in claim 5 further comprising a rotatable control knob for controlling the intensity of said light.

8. An improved keyboard for use with a computer, said keyboard comprising:
a housing board;
a plurality of keys disposed in a predetermined manner on said housing board;
each key having a changeable label thereon including a liquid crystal display (LCD) screen;
a programmable memory disposed within said board, said memory storing display information in a predetermined number of different languages;
a LCD driver means connecting to said keys and said memory;
said driver means simultaneously supplying display information to said keys to cause the keys to display different displays in the same language; and,
a switching means for selecting from said memory a display information for a specific language;
wherein said switching means comprises a manual sliding knob placed on the keyboard which can be moved into different positions depending on the language the user desires; each of said predetermined positions corresponding to a different language programmed in the memory; wherein as said knob is moved from one predetermined position to another, the language display selected from said memory switches accordingly.

9. An improved keyboard as described in claim 8 further comprising a light within each of said keys.

10. An improved keyboard as described in claim 9 further comprising a slideable control knob for controlling the intensity of said light.

11. An improved keyboard as described in claim 9 further comprising a rotatable control knob for controlling the intensity of said light.

12. An improved keyboard for use with a computer, said keyboard comprising:
a housing board;
a plurality of keys disposed in a predetermined manner on said housing board;
each key having a changeable label thereon including a liquid crystal display (LCD) screen;
a programmable memory disposed within said board, said memory storing display information in a predetermined number of different languages;
a LCD driver means connecting to said keys and said memory;
said driver means simultaneously supplying display information to said keys to cause the keys to display different displays in the same language; and,
a switching means for selecting from said memory a display information for a specific language;
wherein said switching means comprises a predetermined number of selection keys disposed on said keyboard; each of said selections keys corresponding to a predetermined language display; wherein selecting a particular selection key selects a corresponding language display program in the memory.

13. An improved keyboard as described in claim 12 further comprising a light within each of said keys.

14. An improved keyboard as described in claim 13 further comprising a slideable control knob for controlling the intensity of said light.

15. An improved keyboard as described in claim 13 further comprising a rotatable control knob for controlling the intensity of said light.

16. In a keyboard comprising a housing member, a plurality of keys disposed on said housing member and extending through said top surface of said housing member, a pair of sheet-like membranes separated by a plastic sheet disposed within said housing member, a circuit board disposed within said housing member, and a key sheet having a plurality of nipple-like flexible protrusions placed over the sheet-like membranes, with the improvement comprising:
a sheet member of a flexible material enclosing said pair of sheet-like membranes, circuit board, and key sheet.

17. A keyboard as described in claim 16 wherein each key has a changeable label thereon, and further comprising:
a programmable memory disposed within said board, said memory storing display information in a predetermined number of different languages;
a driver means connecting to said keys and said memory;
said driver means simultaneously supplying display information to said keys to cause the keys to display different displays in the same language; and,
a switching means for selecting from said memory a display information for a specific language.

18. In a keyboard comprising a housing member, a plurality of keys disposed on said housing member and extending through said top surface of said housing member, a pair of sheet-like membranes separated by a plastic sheet disposed within said housing member, and a circuit board disposed within said housing member, with the improvement comprising:
a sheet member of a flexible material enclosing said pair of sheet-like membranes and circuit board;
said sheet member having a top surface being said surface disposed beneath said keys;
said sheet member having a plurality of nipple-like flexible protrusions protruding therefrom, with each protrusion being positioned beneath a corresponding key.

19. A keyboard as described in claim 18 wherein each key has a changeable label thereon, and further comprising:
a programmable memory disposed within said board, said memory storing display information in a predetermined number of different languages;
a driver means connecting to said keys and said memory;
said driver means simultaneously supplying display information to said keys to cause the keys to display different displays in the same language; and,
a switching means for selecting from said memory a display information for a specific language.
